(19) United States
(12) Patent Application Publication
(10) Pub. No.: US 2023/0130125 A1
(43) Pub. Date: Apr. 27, 2023

(54) COORDINATED MICROSERVICES WORKER THROUGHPUT CONTROL

(71) Applicant: Citrix Systems, Inc., Ft. Lauderdale, FL (US)

(72) Inventors: Jorge Ivan Cifuentes de la Paz, Boca Raton, FL (US); Rodney Gallart Acosta, Pembroke Pines, FL (US)

(73) Assignee: Citrix Systems, Inc., Ft. Lauderdale, FL (US)

(21) Appl. No.: 17/451,713

(22) Filed: Oct. 21, 2021

(51) Int. Cl. G06F 11/34; G06F 9/50; G06F 9/54

(52) U.S. Cl. CPC G06F 11/3442; G06F 11/3409; G06F 9/5055; G06F 9/5038; G06F 9/546; G06F 2209/501; G06F 2209/508

(57) ABSTRACT

Techniques are provided for a coordinated microservice system including a worker orchestrator and multiple worker instances, which are tasked with performing a limited and specific operation, such as reading messages from a queue on behalf of a microservice. In operation, each worker instance of each microservice can use, or otherwise depend upon, one or more external systems or other dependencies to perform at least some of its respective function(s). The worker coordinator is a microservice separate from the workers. The worker orchestrator monitors operational state data from each instance of the workers and computes an updated policy based on an expected throughput that accommodates current load demands. The worker coordinator then sends the policy to the respective microservices, which implement the policy to help to maintain the overall system health.

### BACKGROUND

In a distributed computing environment, various microservices can be deployed across multiple computing platforms to perform specialized operations on behalf of certain applications, such as fetching data in the background. In some situations, one or more microservices rely or otherwise depend on external services to perform certain operations. For example, a microservice can rely on an external service for accessing a back-end database. When many such microservices simultaneously access the external service, or when the external service overwhelms the microservices with messages faster than the microservices can process the messages, system performance can become degraded.

### SUMMARY

One example provides a method of coordinating execution among multiple instances of a microservice. The method includes monitoring, by a first microservice, an operational state of a plurality of workers of a second microservice; generating, by the first microservice, a policy based on the operational state of each of the workers and one or more optimization settings, the policy defining one or more operational parameters of each of the workers; and sending, by the first microservice, the policy to each of the workers. In some examples, the method includes receiving, by each of the workers, the policy, and carrying out, by each of the workers, an operation according to the one or more operational parameters of the policy. In some examples, one of the operational parameters is a message processing delay between a time when a message is received by the respective worker and a time when the worker sends a request to an external dependency, where the operation includes sending the request to the external dependency, and the method includes causing the operation to be carried out after the message processing delay. In some examples, the policy is generated by the first microservice at a first frequency, and the policy is sent to the worker at a second frequency that is greater than or equal to the first frequency. In some examples, the operational state includes one or more of a throughput of each of the workers, process metrics of each of the workers, a throttled calls count of each of the workers, and queue reader settings of each of the workers. In some examples, the one or more optimization settings include one or more of a minimum throttling rate, a maximum overall processing consumption, and a total-time-to-live for one or more messages in the queue. In some examples, the policy defines one or more of a number of concurrent message readers, a message processing delay, and a size of a worker message queue.

Another example provides a computer program product including one or more non-transitory machine-readable mediums having instructions encoded thereon that when executed by at least one processor cause a process to be carried out. The process includes monitoring, by a first microservice, an operational state of a plurality of workers of a second microservice; generating, by the first microservice, a policy based on the operational state of each of the workers and one or more optimization settings, the policy defining one or more operational parameters of each of the workers; and sending, by the first microservice, the policy to each of the workers. In some examples, the process includes receiving, by each of the workers, the policy, and carrying out, by each of the workers, an operation according to the one or more operational parameters of the policy. In some examples, one of the operational parameters is a message processing delay between a time when a message is received by the respective worker and a time when the worker sends a request to an external dependency, where the operation includes sending the request to the external dependency, and the process includes causing the operation to be carried out after the message processing delay. In some examples, the policy is generated by the first microservice at a first frequency, and the policy is sent to the worker at a second frequency that is greater than or equal to the first frequency. In some examples, the operational state includes one or more of a throughput of each of the workers, process metrics of each of the workers, a throttled calls count of each of the workers, and queue reader settings of each of the workers. In some examples, the one or more optimization settings include one or more of a minimum throttling rate, a maximum overall processing consumption, and a total-time-to-live for one or more messages in the queue. In some examples, the policy defines one or more of a number of concurrent message readers, a message processing delay, and a size of a worker message queue.

Yet another example provides a system including a storage and at least one processor operatively coupled to the storage. The at least one processor is configured to execute instructions stored in the storage that when executed cause the at least one processor to carry out a process including monitoring, by a first microservice, an operational state of a plurality of workers of a second microservice; generating, by the first microservice, a policy based on the operational state of each of the workers and one or more optimization settings, the policy defining one or more operational parameters of each of the workers; and sending, by the first microservice, the policy to each of the workers. In some examples, the process includes receiving, by each of the workers, the policy, and carrying out, by each of the workers, an operation according to the one or more operational parameters of the policy. In some examples, one of the operational parameters is a message processing delay between a time when a message is received by the respective worker and a time when the worker sends a request to an external dependency, where the operation includes sending the request to the external dependency, and the process includes causing the operation to be carried out after the message processing delay. In some examples, the policy is generated by the first microservice at a first frequency, and the policy is sent to the worker at a second frequency that is greater than or equal to the first frequency. In some examples, the operational state includes one or more of a throughput of each of the workers, process metrics of each of the workers, a throttled calls count of each of the workers, and queue reader settings of each of the workers. In some examples, the one or more optimization settings include one or more of a minimum throttling rate, a maximum overall processing consumption, and a total-time-to-live for one or more messages in the queue.

Other aspects, examples, and advantages of these aspects and examples, are discussed in detail below. It will be understood that the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a coordinated microservice system, in accordance with an example of the present disclosure.

FIG. 2 is a data flow diagram of worker processing at runtime, in accordance with an example of the present disclosure.

FIG. 3 is a data flow diagram of worker orchestration operations, in accordance with an example of the present disclosure.

FIG. 4 is a flow diagram of an example method for coordinated microservice worker throughput control, in accordance with an example of the present disclosure.

### DETAILED DESCRIPTION

Overview

According to some examples of the present disclosure, a coordinated microservice system includes a worker orchestrator and multiple services (e.g., microservices), which interact with each other. Each of the microservices can have multiple execution instances, which run independently of each other (e.g., simultaneously) and are not necessarily aware of each other. The microservices can, for example, access software, perform functions, and enable modularity across a distributed, service-oriented system. Furthermore, each of the microservices can include one or more workers, which are tasked with performing a limited and specific operation, such as reading messages from a queue on behalf of the microservice. In operation, each worker instance of each microservice can use, or otherwise depend upon, one or more external systems or other dependencies to perform at least some of its respective function(s). A worker coordinator is a microservice separate from the workers. The worker orchestrator monitors operational state data from each instance of the workers and computes an updated policy based on an expected throughput that accommodates current load demands. The worker coordinator then sends the policy to the respective microservices, which implement the policy to help to maintain overall system health. Further examples will be apparent in view of this disclosure.

Microservices are a type of service that can be deployed in clusters, where several instances of the service are always running. Keeping several instances active can increase performance and availability of the microservice. Microservices can be designed to control their internal operational states and behavior autonomously without regard to the statuses of other running services' instances or dependencies, and without any centralized management, coordination, or control. However, this lack of coordination among services leads to significant inefficiencies, particularly when the services experience a contingent event (e.g., a fault or other incident), excessively high demand (e.g., demand exceeding the available capacity of the resources), or other irregularity (e.g., operational unavailability). Some of the undesired effects of these inefficiencies can include excessive throttling, suboptimal overall throughput and operational limits, and/or unavoidable violations of overall service consumption limits, any of which can result in throttled calls to dependencies, and other resource depletions that degrade or otherwise adversely affect the performance of any or all of the services.

In some examples, a microservice is configured to read data from a queue of messages received from another service or application. At times, the messages may enter the queue at a high rate due to a high level of activity by the service or application generating the messages. If the messages arrive in the queue faster than the microservice can read or otherwise process those messages (e.g., a burst of messages in a short time), or if unread messages accumulate in the queue due to various other reasons, such as processing delays in the microservice or delays caused by other services operating in a faulted or degraded mode, the microservice can experience degraded performance, which can lead to faults or other system failures. For example, if time-sensitive messages are not processed promptly, the data may become stale by the time the message is processed.

To this end, techniques are disclosed for mitigating faults and reducing the risk of system failures by analyzing known scenarios and setting corrective operational parameters on each microservice instance to regulate throughput. In an example, an orchestrating microservice (a first microservice) is configured to receive operational state data, such as current throughput, operating system metrics, and queue state, periodically from several worker instances of a second microservice. Each worker instance is tasked with performing a limited and specific operation, such as reading messages from a queue on behalf of the microservice. The orchestrating microservice computes an updated policy based on an expected throughput that accommodates current load demands and sends the policy to the respective microservices, which implement the policy to help to maintain overall system health. For example, the orchestrating microservice aggregates operational performance data from each microservice worker instance and determines updated throughput settings for each node based on predetermined optimization settings defined in the system. The updated throughput settings can include, for example, a minimum throttling rate (e.g., the maximum rate at which the worker can send messages), the maximum processor consumption rate for generating messages, and/or a time-to-live (TTL) associated with the message send queue (e.g., TTL can be a time that a message persists in the queue before becoming stale and/or discarded).

Once the microservice receives the updated throughput settings, the corresponding worker adjusts the operational parameters based on the settings. For example, the worker can adjust the number of concurrent message readers that retrieve messages from a queue (e.g., increase or decrease the number of messages that can be concurrently processed by each worker, thereby throttling throughput of the respective worker), add or reduce a processing delay for each message (e.g., lower or increase the throughput of the worker), and/or change a size of an internal queue used to serialize calls to one or more target systems (e.g., adjust the number of calls that generate messages sent back to the worker). The operational settings are used to adjust the throughput of worker microservices based on the overall system analysis, which provides an adaptive mechanism to detect and react to certain system operational scenarios, such as load and throughput spikes caused by one service that may overwhelm other services with messages.

Example System

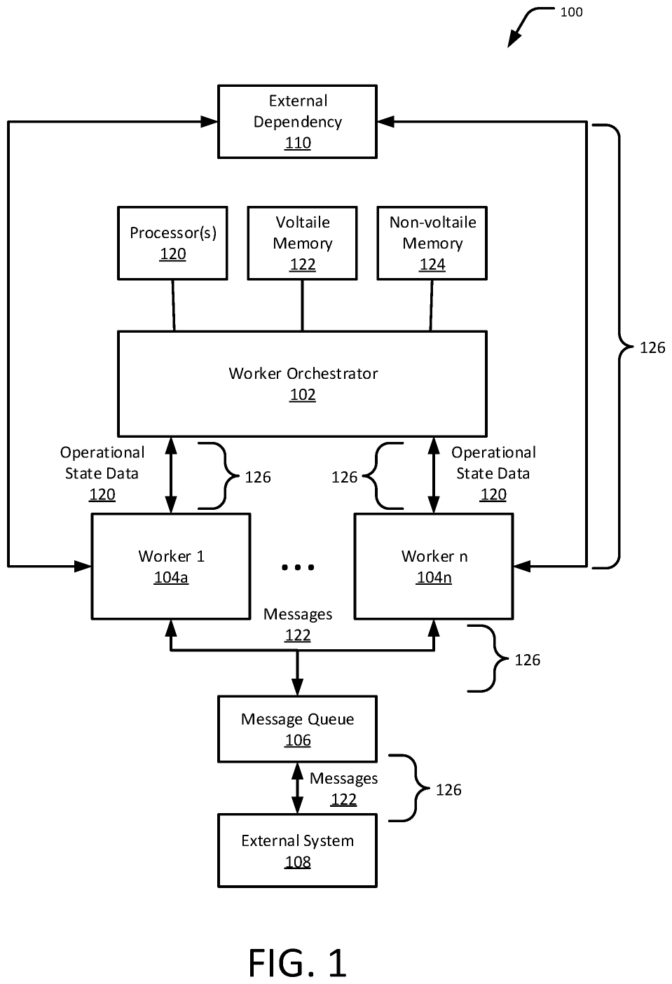

FIG. 1 is a block diagram of a coordinated microservice system 100, in accordance with an example of the present disclosure. The system 100 includes a worker orchestrator 102 (a first microservice), one or more microservice workers 104a . . . 104n of a second microservice, a message queue 106, an external system 108, and an external dependency 110. The workers 104a . . . 104n can, for example, be incorporated into one or more microservices, which are modular component parts of an application that are designed to run independently of other components. For example, microservices can include fine-grained and lightweight services that are relatively small, autonomously developed, independently scalable, and deployed independently of the larger application as modules or components that support or complement the application. In some examples, microservices can have one or more of the following characteristics: microservices run their own processes and communicate with other components and databases via their respective application programming interfaces (APIs); microservices use lightweight APIs to communicate with each other over a network; each microservice can be modified independently without having to rework the entire application; microservices follow a software development lifecycle designed to ensure that it can perform its particular function within the application; each individual microservice performs a specific function, such as adding merchandise to a shopping cart, updating account information, or transacting a payment; and the functionality of a microservice can be exposed and orchestrated by the API of the application, enabling development teams to reuse portions of an existing application to build new applications without starting from scratch.

Each instance of the worker 104a . . . 104n is designed to run independently of other such instances. For instance, the workers 104a . . . 104n can access software, perform functions, and enable modularity across a distributed, service-oriented system. For example, each of the microservices including the workers 104a . . . 104n can include a full runtime environment with libraries, configuration files, and dependencies for performing the respective functions of each service. The microservices each include APIs to communicate with each other and with other services, such as the external system 108 (via the message queue 106) and the external dependency 110. The external dependency 110 can include any service or other application that is external to the workers 104a . . . 104n and which one or more of the workers 104a . . . 104n depend upon for performing certain tasks.

In some examples, the workers 104a . . . 104n each perform specific functions in conjunction with the external system 108, such as adding merchandise to a virtual shopping cart, updating account information, or transacting a payment. The workers 104a . . . 104n can use the external dependency 110 to perform at least some of these functions (such as requesting data, sending updates, or completing other tasks that are distributed across the system 100). The workers 104a . . . 104n receive messages 122 from the external system 108 via the message queue 106, which can be a serial queue (e.g., first message in the queue is the first message out of the queue). The messages 122 can include requests for the functions to be performed by one or more of the workers 104a . . . 104n.

In some examples, the worker orchestrator 102 is a microservice separate from the workers 104a . . . 104n. The worker orchestrator 102 monitors operational state data 120 from each instance of the workers 104a . . . 104n. The operational state data 120 can be pushed from the workers 104a . . . 104n to the worker orchestrator 102 or polled from the workers 104a . . . 104n by the worker orchestrator 102. The operational state data 120 can include, for example, throughput of each worker 104a . . . 104n, process metrics of each worker 104a . . . 104n, throttled calls count of each worker 104a . . . 104n, and/or queue reader settings of each worker 104a . . . 104n (e.g., the rate or timing at which the worker reads messages from the queue).

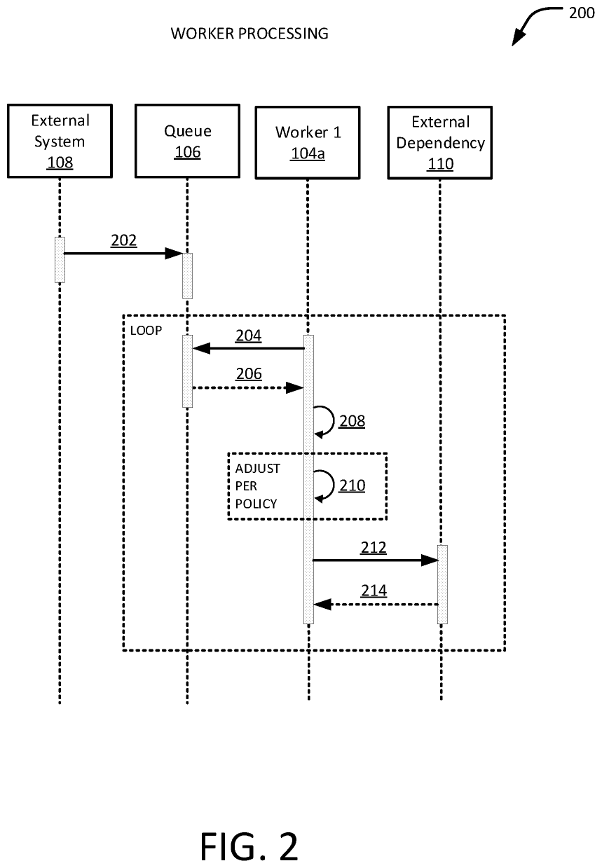

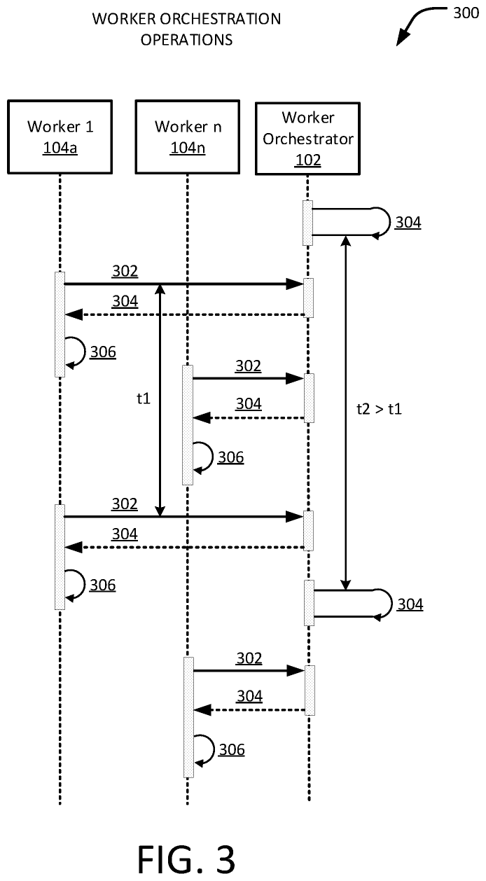

Periodically, the worker orchestrator 102 calculates a policy defining a throughput and/or maximum processing resource allocation (e.g., a percentage of processing time to be allocated for reading messages from the message queue 106) for each of the workers 104a . . . 104n based on the operational state data 120, such as described with respect to FIG. 3. The worker orchestrator 102 then sends the policy to each of the workers 104a . . . 104n. The workers 104a . . . 104n then adjust the operational parameters according to the policy and carry out operations in accordance with the policy, such as described with respect to FIG. 2. In this manner, performance issues related to multi-instance microservices workers (e.g., the workers 104a . . . 104n) can be mitigated by analyzing known scenarios and setting corrective operational parameters using a centralized microservice (e.g., the worker orchestrator 102).

In some examples, the system 100 can include a workstation, a laptop computer, a tablet, a mobile device, or any suitable computing or communication device. One or more components of the system 100, including the worker orchestrator 102, the workers 104a . . . 104n, the message queue 106, the external system 108, and the external dependency 110, can include or otherwise be executed using one or more processors 120, volatile memory 122 (e.g., random access memory (RAM)), non-volatile machine-readable mediums 124 (e.g., memory), one or more network or communication interfaces, a user interface (UI), a display screen, and a communications bus 126. The non-volatile (non-transitory) machine-readable mediums can include: one or more hard disk drives (HDDs) or other magnetic or optical machine-readable storage media; one or more machine-readable solid state drives (SSDs), such as a flash drive or other solid-state storage media; one or more hybrid machine-readable magnetic and solid-state drives; and/or one or more virtual machine-readable storage volumes, such as a cloud storage, or a combination of such physical storage volumes and virtual storage volumes or arrays thereof. The user interface can include one or more input/output (I/O) devices (e.g., a mouse, a keyboard, a microphone, one or more speakers, one or more biometric scanners, one or more environmental sensors, and one or more accelerometers, etc.). The display screen can provide a graphical user interface (GUI) and in some cases, may be a touchscreen or any other suitable display device. The non-volatile memory stores an operating system, one or more applications, and data such that, for example, computer instructions of the operating system and the applications, are executed by processor(s) out of the volatile memory. In some examples, the volatile memory can include one or more types of RAM and/or a cache memory that can offer a faster response time than a main memory. Data can be entered through the user interface. Various elements of the system 100 (e.g., including the worker orchestrator 102, the workers 104a . . . 104n, the message queue 106, the external system 108, and the external dependency 110) can communicate via the communications bus 126 or another data communication network.

The system 100 described herein is an example computing device and can be implemented by any computing or processing environment with any type of machine or set of machines that can have suitable hardware and/or software capable of operating as described herein. For example, the processor(s) of the system 100 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals. In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory. The processor can be analog, digital, or mixed. In some examples, the processor can be one or more physical processors, which may be remotely located or local. A processor including multiple processor cores and/or multiple processors can provide functionality for parallel, simultaneous execution of instructions or for parallel, simultaneous execution of one instruction on more than one piece of data.

The network interfaces can include one or more interfaces to enable the system 100 to access a computer network such as a Local Area Network (LAN), a Wide Area Network (WAN), a Personal Area Network (PAN), or the Internet through a variety of wired and/or wireless connections, including cellular connections. In some examples, the network may allow for communication with other computing platforms, to enable distributed computing. In some examples, the network may allow for communication with the worker orchestrator 102, the workers 104a . . . 104n, the message queue 106, the external system 108, and the external dependency 110, and/or other parts of the system 100 of FIG. 1.

Adaptive Microservices Worker Throughput Control

FIG. 2 is a data flow diagram 200 of worker processing at runtime, in accordance with an example of the present disclosure. As noted above, the worker orchestrator 102 assists with regulating throughput of the workers 104a . . . 104n that are servicing the message queue 106. The external system 108 pushes a message 202 to the queue 106. Within a loop, and while at least one message is in the queue 106, the worker 104a (or any other worker) sends a get message request 204 to the queue 106, which returns a message 206 to the worker 104a. Next, the worker 104a retrieves a current policy 208, which is set by the worker orchestrator 102, and adjusts an operation of the worker 104a according to the policy. In this example, the policy 208 defines a delay 210 between the time when the message 206 is received by the worker 104a and the time when the worker 104a sends a request 212 to the external dependency 110, upon which the external dependency 110 acknowledges 214 the request 212. In some other examples, the policy 208 can define other operational parameters of the worker 104a, such as changing the number of messages concurrently read from the queue 106 or changing the size of an internal queue (e.g., internal to the worker 104a) used to serialize calls or other requests to the external dependency 110. The loop can execute indefinitely during the life of the worker 104a instance.

FIG. 3 is a data flow diagram 300 of worker orchestration operations, in accordance with an example of the present disclosure. The worker orchestrator 102 periodically (e.g., every time interval t1 or at a frequency 1/t1) receives status data 302 from each of the workers 104a . . . 104n. The worker orchestrator 102 periodically (e.g., every time interval t2 or at a frequency 1/t2) processes the status data to generate an updated worker policy 304. To guarantee multiple receipts of status data between updating the worker policy, the time interval t2 can be greater than t1 (e.g., t2>3*t1), although it will be understood that the time interval t2 can be the same as or less than t1. The worker orchestrator 102 returns the most recent worker policy 304 to each respective worker 104a . . . 104n in response to receiving the status data 302. In response to receiving the worker policy 304, each worker 104a . . . 104n updates operational parameters 306 according to the policy 304 and carries out operations in accordance with the policy 304, such as described with respect to FIG. 2.

Example Use Case

A health-data worker (e.g., the first worker 104a), via a message queue (e.g., the message queue 106), processes health data messages from an external health data system (e.g., the external system 108). The health data messages should be processed in real-time or near real-time, or at least before messages become stale. A logger-worker (e.g., a second worker 104b), via the same message queue (e.g., the message queue 106), log data messages from an external log data system (e.g., another external system 108). The log data messages are destined for a long-term datastore and have no timing requirement because the messages do not become stale. In this scenario, the queue is providing messages (e.g., the health data messages and the log data messages) to both the health-data worker and the logger-worker. Under certain conditions, the external log data system can potentially send a large number of log messages in a short amount of time (e.g., a spike or surge of messages). Such a spike or surge could fill the queue with log messages faster than the logger-worker can read them. In the meantime, any health data messages arriving the queue from the external health data system may be delayed pending the processing of the log messages, such as when the queue is first-in-first-out. Under these conditions, the workers orchestrator 102 can, for example, change the policy used by the workers 104a . . . 104n to set their operational parameters, such as by increasing the rate at which the logger-worker processes the log messages to more quickly clear the queue and reduce the delay for processing the pending health data messages. Other policy examples include changing the number of messages the workers 104a . . . 104n can concurrently read from the queue 106 to increase the rate at which the messages are processed, thus reducing backlog in the queue 106 and allowing the time sensitive health data messages to be processed before they become stale.

Example Method

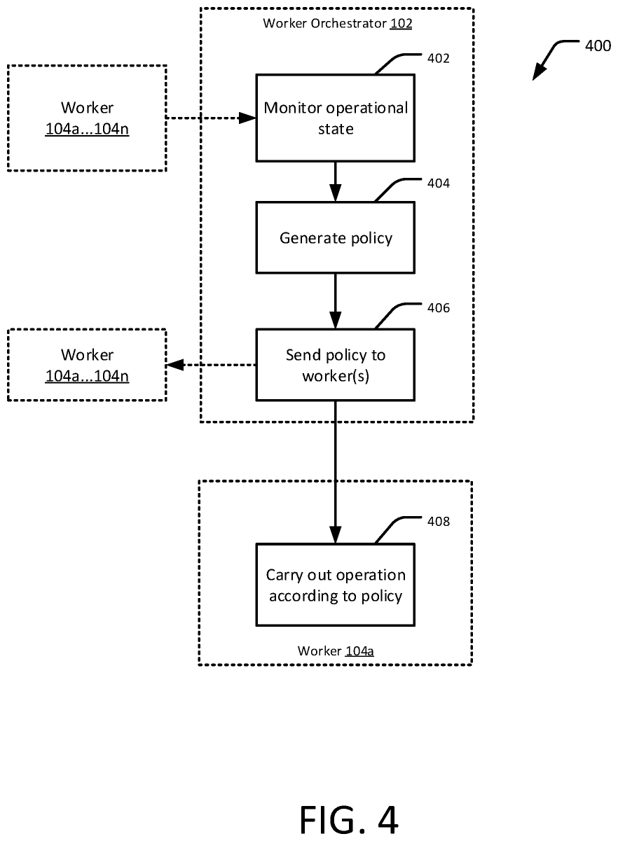

FIG. 4 is a flow diagram of an example method 400 for coordinated microservice worker throughput control, in accordance with an example of the present disclosure. The method can be implemented, for example, by the worker orchestrator 102, the workers 104a . . . 104n, and/or other components of the system 100 of FIG. 1. The method 400 includes monitoring 402, by a first microservice (e.g., the worker orchestrator 102), an operational state of a plurality of workers of a second microservice (e.g., the workers 104a . . . 104n). The method 400 further includes generating 404, by the first microservice, a policy based on the operational state of each of the workers and one or more optimization settings. The policy defines one or more operational parameters of each of the workers. For example, the policy can define one or more of a number of concurrent message readers, a message processing delay, and/or a size of a worker message queue. The method 400 further includes sending 406, by the first microservice, the policy to each of the workers.

In some examples, the method 400 includes receiving and carrying out 408, by each of the workers, the policy, and carrying out, by each of the workers, an operation according to the one or more operational parameters of the policy, such as discussed with respect to FIG. 2. In some examples, at least one of the operational parameters is a message processing delay between a time when a message is received by the respective worker and a time when the worker sends a request to an external dependency and the operation includes sending the request to the external dependency. In this case, the method further comprises causing the operation to be carried out after the message processing delay, such as discussed with respect to FIG. 2 (e.g., the delay 210).

In some examples, the policy is generated by the first microservice at a first frequency (e.g., 1/t1), and the policy is sent to the worker at a second frequency that is greater than or equal to the first frequency (e.g., 1/t2>=1/t1). In some examples, the operational state includes one or more of a throughput of each of the workers, process metrics of each of the workers, a throttled calls count of each of the workers, and queue reader settings of each of the workers. In some examples, the one or more optimization settings include one or more of a minimum throttling rate, a maximum overall processing consumption, and a total-time-to-live for one or more messages in the queue.

The foregoing description and drawings of various embodiments are presented by way of example only. These examples are not intended to be exhaustive or to limit the present disclosure to the precise forms disclosed. Alterations, modifications, and variations will be apparent in light of this disclosure and are intended to be within the scope of the present disclosure as set forth in the claims.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method of coordinating execution among multiple instances of a microservice, the method comprising:
monitoring, by a first microservice, an operational state of a plurality of workers of a second microservice;
generating, by the first microservice, a policy based on the operational state of each of the workers and one or more optimization settings, the policy defining one or more operational parameters of each of the workers; and
sending, by the first microservice, the policy to each of the workers.

2. The method of claim 1, further comprising receiving, by each of the workers, the policy, and carrying out, by each of the workers, an operation according to the one or more operational parameters of the policy.

3. The method of claim 2, wherein one of the operational parameters is a message processing delay between a time when a message is received by the respective worker and a time when the worker sends a request to an external dependency, wherein the operation includes sending the request to the external dependency, and wherein the method further comprises causing the operation to be carried out after the message processing delay.

4. The method of claim 1, wherein the policy is generated by the first microservice at a first frequency, and wherein the policy is sent to the worker at a second frequency that is greater than or equal to the first frequency.

5. The method of claim 1, wherein the operational state includes one or more of a throughput of each of the workers, process metrics of each of the workers, a throttled calls count of each of the workers, and queue reader settings of each of the workers.

6. The method of claim 1, wherein the one or more optimization settings include one or more of a minimum throttling rate, a maximum overall processing consumption, and a total-time-to-live for one or more messages in the queue.

7. The method of claim 1, wherein the policy defines one or more of a number of concurrent message readers, a message processing delay, and a size of a worker message queue.

8. A computer program product including one or more non-transitory machine-readable mediums having instructions encoded thereon that when executed by at least one processor cause a process to be carried out, the process comprising:
monitoring, by a first microservice, an operational state of a plurality of workers of a second microservice;
generating, by the first microservice, a policy based on the operational state of each of the workers and one or more optimization settings, the policy defining one or more operational parameters of each of the workers; and
sending, by the first microservice, the policy to each of the workers.

9. The computer program product of claim 8, wherein the process includes receiving, by each of the workers, the policy, and carrying out, by each of the workers, an operation according to the one or more operational parameters of the policy.

10. The computer program product of claim 9, wherein one of the operational parameters is a message processing delay between a time when a message is received by the respective worker and a time when the worker sends a request to an external dependency, wherein the operation includes sending the request to the external dependency, and wherein the process includes causing the operation to be carried out after the message processing delay.

11. The computer program product of claim 8, wherein the policy is generated by the first microservice at a first frequency, and wherein the policy is sent to the worker at a second frequency that is greater than or equal to the first frequency.

12. The computer program product of claim 8, wherein the operational state includes one or more of a throughput of each of the workers, process metrics of each of the workers, a throttled calls count of each of the workers, and queue reader settings of each of the workers.

13. The computer program product of claim 8, wherein the one or more optimization settings include one or more of a minimum throttling rate, a maximum overall processing consumption, and a total-time-to-live for one or more messages in the queue.

14. The computer program product of claim 8, wherein the policy defines one or more of a number of concurrent message readers, a message processing delay, and a size of a worker message queue.

15. A system comprising:
a storage; and
at least one processor operatively coupled to the storage, the at least one processor configured to execute instructions stored in the storage that when executed cause the at least one processor to carry out a process including
monitoring, by a first microservice, an operational state of a plurality of workers of a second microservice;
generating, by the first microservice, a policy based on the operational state of each of the workers and one or more optimization settings, the policy defining one or more operational parameters of each of the workers; and
sending, by the first microservice, the policy to each of the workers.

16. The system of claim 15, wherein the process includes receiving, by each of the workers, the policy, and carrying out, by each of the workers, an operation according to the one or more operational parameters of the policy.

17. The system of claim 16, wherein one of the operational parameters is a message processing delay between a time when a message is received by the respective worker and a time when the worker sends a request to an external dependency, wherein the operation includes sending the request to the external dependency, and wherein the process includes causing the operation to be carried out after the message processing delay.

18. The system of claim 15, wherein the policy is generated by the first microservice at a first frequency, and wherein the policy is sent to the worker at a second frequency that is greater than or equal to the first frequency.

19. The system of claim 15, wherein the operational state includes one or more of a throughput of each of the workers, process metrics of each of the workers, a throttled calls count of each of the workers, and queue reader settings of each of the workers.

20. The system of claim 15, wherein the one or more optimization settings include one or more of a minimum throttling rate, a maximum overall processing consumption, and a total-time-to-live for one or more messages in the queue.
